(19) United States
(12) Patent Application Publication
(10) Pub. No.: US 2014/0130889 A1
(43) Pub. Date: May 15, 2014

(54) AIR INLET STRUCTURE FOR TURBOJET ENGINE NACELLE

(71) Applicant: AIRCELLE, Gonfreville L'Orcher (FR)

(72) Inventor: Nicolas DEZEUSTRE, Le Havre (FR)

(73) Assignee: AIRCELLE, Gonfreville L'Orcher (FR)

(21) Appl. No.: 14/093,903

(22) Filed: Dec. 2, 2013

Related U.S. Application Data
(63) Continuation of application No. PCT/FR2012/051046, filed on May 11, 2012.

(30) Foreign Application Priority Data
Jun. 1, 2011 (FR) 11/54810

(51) Int. Cl. F02C 7/04

(52) U.S. Cl. CPC F02C 7/04
USPC 137/15.1

(57) ABSTRACT

The present disclosure relates to an air inlet structure for a turbojet engine nacelle. The air inlet structure has a stationary internal wall to be attached to one element of a mid-section of the nacelle, and a longitudinal external wall extended by an air inlet lip connected to the stationary internal wall. In particular, one portion forming the air inlet lip is provided with depressurizing openings for a part of the air inlet lip.

### CROSS-REFERENCE TO RELATED APPLICATIONS

This application is a continuation of International Application No. PCT/FR2012/051046, filed on May 11, 2012, which claims the benefit of FR 11/54810, filed on Jun. 1, 2011. The disclosures of the above applications are incorporated herein by reference.

### FIELD

The present disclosure relates to an air inlet structure for a turbojet engine nacelle capable of channeling a flow of air toward a fan of the turbojet engine.

### BACKGROUND

The statements in this section merely provide background information related to the present disclosure and may not constitute prior art.

An airplane is propelled by one or more propulsion assemblies comprising a turbojet engine housed in a tubular nacelle. Each propulsion assembly is attached to the airplane by a mast generally situated below a wing or at the fuselage.

A nacelle generally has a structure comprising an air inlet upstream from the engine, a midsection intended to surround a fan of the turbojet engine, and a downstream section housing thrust reverser means and intended to surround the combustion chamber of the turbojet engine, and generally ends with a jet nozzle whereof the outlet is situated downstream from the turbojet engine.

The air inlet comprises an air inlet lip on the one hand, suitable for allowing the optimal capture toward the turbojet engine of the air necessary to supply the fan and the internal compressors of the turbojet engine, and on the other hand a downstream structure on which the lip is attached and intended to channel the air suitably toward the blades of the fan. The assembly is attached upstream from a fan case belonging to the midsection of the nacelle.

More specifically, the air inlet structure generally has a substantially annular downstream structure comprising an outer surface ensuring the outer aerodynamic continuity of the nacelle and an inner surface ensuring the inner aerodynamic continuity of the nacelle. The air inlet lip provides the upstream junction between these two walls.

An air inlet lip structure may comprise many components and has various pieces of equipment, in particular deicing equipment, for example. Furthermore, the junctions between the different walls and elements make the structure heavier and have a negative impact on the aerodynamic performance.

In order to resolve these problems, so called laminar nacelles have been developed with an air inlet structure having an outer continuity improving the aerodynamic performance. Such a structure is in particular described in document FR 2,906,568.

Owing to the fact that, in such an air inlet, the lip is in fact integrated into the external wall, the junctions between these members capable of harming the aerodynamic performance of the nacelle are eliminated. One thus obtains a so-called “laminar” cowl, frequently called LFC (Laminar Forward Cowl).

Furthermore, maintenance operations are made easier by making the external wall of the lip translatable, the internal wall then constituting a stationary shroud. This stationery shroud is generally equipped with sound attenuation means.

One drawback of this type of air inlet lies in the junction area between the inner edge of the lip and the upstream edge of the stationary internal wall, that area being capable of undergoing axial movements or even opening in certain operating configurations of the engine.

In fact, the integral and movable external wall remains heavy and tends to move under load. In order to avoid these movements, the air inlet must be equipped with reinforcing means, which increases its mass and are therefore not desirable.

More specifically, the risk of opening of this junction area with the stationary internal wall in particular appears when the aircraft is at its “stationary point” just before taking off, and the engines are running at full speed while the aircraft is still immobilized: during this phase, the suction force exerted by the fan of the turbojet engine rises to the outside of the upstream structure of the nacelle, creating detachment forces of the lip relative to the stationary shroud of the cowl.

This detachment results in deteriorating the aerodynamic performance of the inner face of the air inlet, and leading to sealing flaws that may harm the longevity and proper operation of the members (electric, hydraulic, pneumatic, etc.) situated inside the air inlet.

Furthermore, the thickness of the air inlet lip remains relatively high in this type of structure, in particular to contribute to the mechanical strength of the assembly, which limits the implementation of electrical deicing devices using heating resistances. The implementation of such deicing devices is essential for such an air inlet, which, due to its structure, is difficult to make compatible with the typical hot air pneumatic solutions.

There is therefore a need to decrease the deformation and the mass of this type of structure.

To partially resolve this problem, several solutions for the placement of reinforcements have been developed. Examples in particular include documents FR 2,927,609 and unpublished French application 11/50890.

### SUMMARY

The present disclosure provides an air inlet structure for a turbojet engine nacelle comprising at least one stationary internal wall intended to be attached to at least one element of a midsection of the nacelle on the one hand, and at least one longitudinal external wall extended by an air inlet lip connected to the stationary internal wall on the other hand, characterized in that at least the portion forming the air inlet lip is equipped with depressurizing means for at least part of the lip.

In fact, it has been surprisingly observed that during operation, the air inlet lip undergoes pressure charging creating suction of the latter toward the front of the nacelle.

Without wishing to be bound by any theory, this may result from flows of air surrounding the air inlet lip. In fact, the air flowing at a high speed around the nacelle, the air pressure at the air inlet lip is low, the air present being quickly suctioned toward the downstream direction of the nacelle.

In order to compensate for these forward deformations, the present disclosure, by depressurizing the air inlet lip, makes it possible to generate suction forces inside the lip that balance the forces of the forward deformations and thus counterbalance the deformations undergone by the air inlet lip.

As a result, the mechanical stresses undergone by the air inlet lip are lower, which in particular makes it possible to reduce the thickness of that lip.

Furthermore, these internal suction forces help keep the air inlet lip against the stationary internal wall and thereby reduce the parasitic axial movements. The general mechanical strength of the air inlet structure is therefore greatly improved as a result, and it is therefore possible to provide a thinner air inlet lip facilitating the integration of electrical deicing means.

Advantageously, the air inlet lip is equipped with at least one partition defining, with the air inlet lip, at least one air inlet lip compartment, said compartment being associated with the depressurizing means.

Advantageously, the partition may comprise at least one acoustic panel.

According to a first form, the depressurizing means comprise at least one pump, in particular an electric pump.

Advantageously, the pump has a suction outlet emerging downstream from the air inlet lip, in particular, for example, in the external wall, in the internal wall, downstream from the fan.

Alternatively or additionally, the depressurizing means comprise at least one opening formed in the external wall.

According to one form, the openings are formed in the wall of the lip near the stationary internal wall.

Advantageously, at least part of the openings are positioned along a substantially peripheral line of the air inlet lip.

According to a first form, the openings comprise substantially round openings.

Alternatively or additionally, the openings comprise oblong openings, the large axis of the oblong opening being oriented along a line peripheral to the air inlet.

Still alternatively or additionally, the openings comprise openings made in the form of serrations open at a contact line of the external wall with the internal wall and thereby making it possible to limit the contact surface between the air inlet lip and the stationary wall.

Advantageously, the longitudinal external wall is removable. Also advantageously, the longitudinal external wall is mounted translatably.

Advantageously, the element of the midsection of the nacelle is a fan case.

In one form, the air inlet lip is integrated into the external wall.

Advantageously, the internal wall is equipped with sound attenuation means.

The present disclosure also of course relates to a turbojet engine nacelle comprising such an air inlet structure.

### DRAWINGS

In order that the disclosure may be well understood, there will now be described various forms thereof, given by way of example, reference being made to the accompanying drawings, in which:

FIG. 1 is a longitudinal cross-sectional view of an air inlet structure for a turbojet engine nacelle according to the prior art;

FIG. 2 is a diagrammatic cross-sectional illustration of the forces exerted on the air inlet lip of the structure of FIG. 1;

FIG. 3 is a diagrammatic cross-sectional illustration of an air inlet structure according to the present disclosure having means for depressurizing the air inlet lip;

FIGS. 4 to 6 are diagrammatic illustrations of different forms of openings for depressurizing the air inlet of FIG. 3; and

FIG. 7 shows an alternative form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

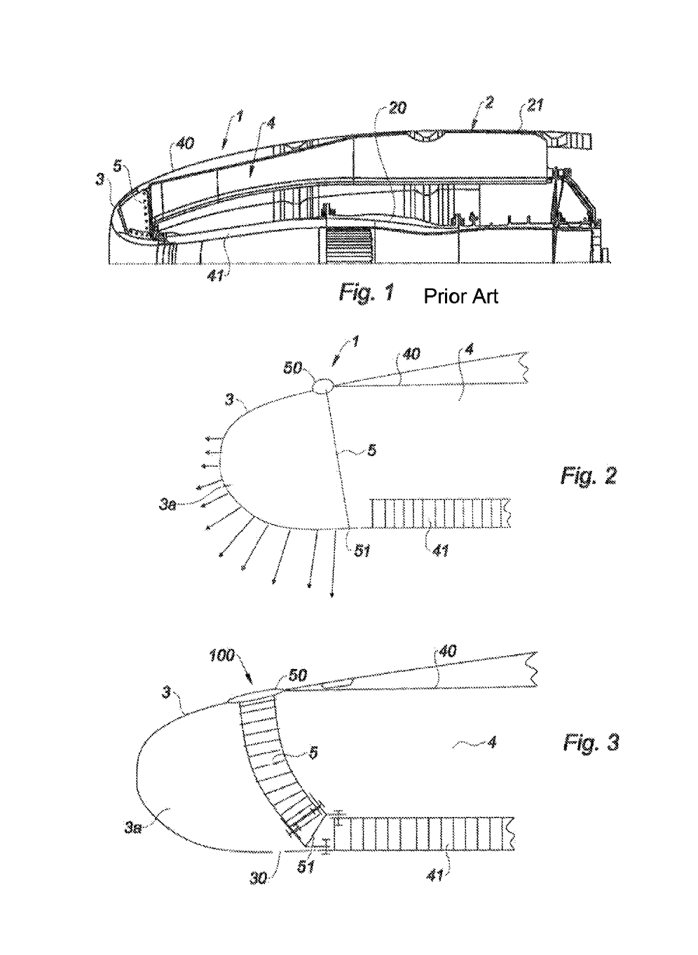

The nacelle generally has a substantially tubular structure comprising an air inlet upstream from the engine (FIG. 1), a midsection intended to surround a fan of the turbojet engine, and a downstream section housing thrust reverser means and intended to surround the combustion chamber of the turbojet engine, and generally ends with a jet nozzle, the outlet of which is situated downstream from the turbojet engine.

FIG. 1 shows a longitudinal cross-sectional view of an air inlet structure 1 according to the prior art.

This air inlet structure 1 is situated upstream from the midsection 2 of the nacelle and comprises an air inlet lip 3 on the one hand, suitable for allowing an optimal capture toward the turbojet engine of the air necessary for the supply thereof, and a downstream structure 4 on the other hand, on which the lip is attached and intended to channel the air suitably toward the blades of the fan.

More specifically, the air inlet structure 1 generally has a substantially annular downstream structure 4 comprising an external wall 40 ensuring the outer aerodynamic continuity of the nacelle and an internal wall 41 ensuring the inner aerodynamic continuity of the nacelle.

The air inlet lip 3 provides the upstream junction between these two walls 40, 41.

The internal wall 41 is generally attached to a fan case 20 belonging to the midsection 2 and with which it forms a stationary structure.

The external wall 40 is generally attached to an external wall 21 of the midsection, with which it ensures the outer aerodynamic continuity.

It should also be specified that the air inlet lip 3 is generally separated from the downstream part 40 of the air inlet lip 1 by a partition 5 contributing to the strength of the assembly and defining, with the lip 3, a compartment 3a inside said lip 3.

Frequently, the external wall 40 may be attached thereto removably so as to allow access to the inside of the air inlet structure 1, in particular to access internal equipment such as a deicing system of the air inlet 1 and the lip 3.

In the case of so-called laminar nacelles, the air inlet lip 3 is an integral part of the external wall 40, which extends so as to form a single panel generally translatably mounted toward the front of the nacelle.

As shown diagrammatically in FIG. 2, during operation, the air inlet lip 3 undergoes a forward pressure load (bend) which tends to deform the air inlet lip 3, which must therefore have a certain mechanical strength, generally by providing a sufficient lip thickness 3.

The wall 5 is rigidly fixed in 51 with the internal wall 41. At a zone 50, if the external wall 40 is mounted translatable toward the front in the axis of the engine, this junction may be embodied by a single joint. If the external wall 40 opens, this junction is then rigid, for example using fasteners.

According to the present disclosure, these pressure load forces are compensated by depressurizing the air inlet lip 3, and more particularly the compartment 3a, if applicable.

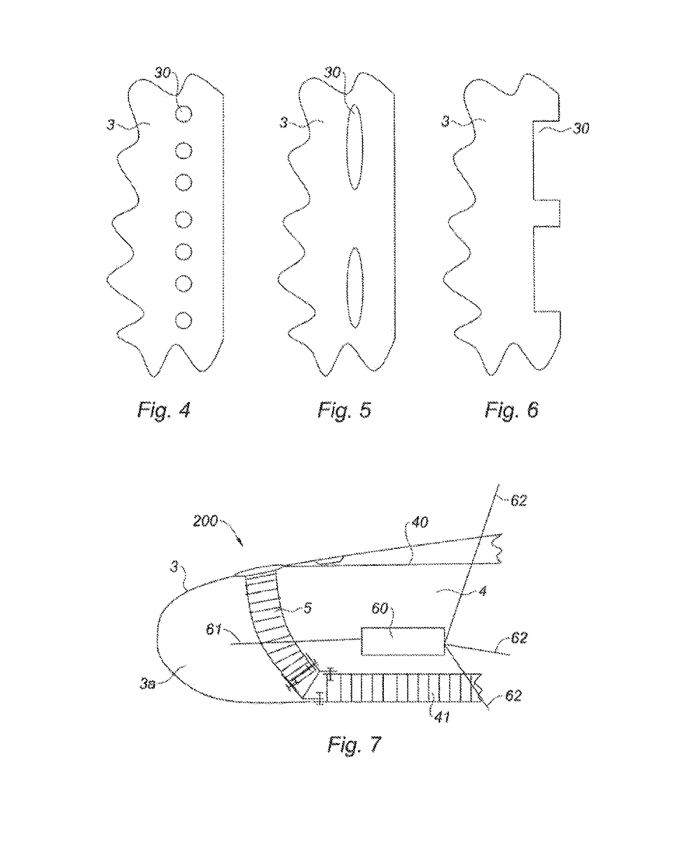

A first form of the present disclosure is shown in FIG. 4. In this form, an air inlet structure 100, which is similar to the air inlet structure 1, is equipped with depressurizing means for the compartment 3a of the air inlet lip 3 assuming the form of openings 30 formed in the wall of the air inlet lip.

Advantageously, these openings 30 are situated on an internal face of the air inlet structure, near the internal wall 41 and its junction with said air inlet lip 3.

Also advantageously, the openings 30 are positioned along a substantially peripheral line of the air inlet structure.

Thus, due to the flow of the air suctioned by the fan through the nacelle, the pressure of the air at the upstream level of the air inlet is extremely reduced. Owing to the presence of openings 30, the air present inside the compartment 3a of the air inlet lip 3 is suctioned by the flow of air. This results in a pressure drop inside said compartment 3a.

FIGS. 4 to 6 show different forms of the openings 30 making it possible to depressurize the compartment 3a of the air inlet lip 3.

The openings 30 may in particular be circular (FIG. 4) or oblong (FIG. 5).

They may also be made at a contact and bearing line between the air inlet lip 3 and the internal wall 41, in particular in the form of separations formed in said contact line.

It is additionally possible to provide for the use of caps on the openings 30 making it possible to improve the air flows and attenuate the aerodynamic disruptions due to the openings.

FIG. 7 shows a second form of the present disclosure. FIG. 7 shows an air inlet structure 200 that differs from the air structure 100 in that the means for depressurizing the air inlet lip 3 compartment 3a comprise an electric pump 60, having a suction duct 61 emerging in the compartment 3a of the air inlet lip 3 and a delivery duct for delivering the suctioned air 62. The delivery duct emerges in a downstream part of the air inlet 200. It is possible to provide that this duct 62 for example emerges in the external wall 40, in the internal wall 41 near the fan, or still further downstream from the fan and the compressor.

Although the present disclosure has been described with one particular example form, it is of course in no way limited thereto and encompasses all technical equivalents of the described means as well as combinations thereof if they are within the scope of the present disclosure.

What is claimed is:

1. An air inlet structure for a turbojet engine nacelle comprising at least one stationary internal wall attached to at least one element of a midsection of the nacelle, and at least one longitudinal external wall extended by an air inlet lip connected to the stationary internal wall, wherein at least one portion forming the air inlet lip is equipped with depressurizing means for at least part of the air inlet lip.

2. The air inlet structure according to claim 1, wherein the air inlet lip is equipped with at least one partition defining, with the air inlet lip, at least one air inlet lip compartment, said air inlet lip compartment being associated with the depressurizing means.

3. The air inlet structure according to claim 1, wherein the depressurizing means comprise at least one pump.

4. The air inlet structure according to claim 3, wherein the at least one pump is an electric pump.

5. The air inlet structure according to claim 3, wherein the pump has a suction outlet emerging downstream from the air inlet lip.

6. The air inlet structure according to claim 3, the pump has a suction outlet emerging in the external wall, in the internal wall, or downstream from the fan.

7. The air inlet structure according to claim 1, wherein the depressurizing means comprise at least one opening formed in the external wall.

8. The air inlet structure according to claim 7, wherein the openings are formed in the wall of the air inlet lip near the stationary internal wall.

9. The air inlet structure according to claim 7, characterized in that at least part of the openings are positioned along a substantially peripheral line of the air inlet lip.

10. The air inlet structure according to claim 7, wherein the openings comprise substantially round openings.

11. The air inlet structure according to claim 7, wherein the openings comprise oblong openings, the large axis of the oblong opening being oriented along a line peripheral to the air inlet.

12. The air inlet structure according to claim 7, wherein the openings comprise openings made in the form of serrations open at a contact line of the external wall with the internal wall and thereby making it possible to limit a contact surface between the air inlet lip and the stationary wall.

13. The air inlet structure according to claim 1, wherein the longitudinal external wall is mounted translatably.

14. The air inlet structure according to claim 1, wherein the at least one element of the midsection of the nacelle is a fan case.

15. The air inlet structure according to claim 1, wherein the air inlet lip is integrated into the external wall.
